(19) United States
(12) Patent Application Publication
(10) Pub. No.: US 2014/0236847 A1
(43) Pub. Date: Aug. 21, 2014

(54) Synchronized Wearable Electronic Elements

(71) Applicant: Christopher Chad Hamilton, Kirkland, WA (US)

(72) Inventor: Christopher Chad Hamilton, Kirkland, WA (US)

(21) Appl. No.: 14/163,729

(22) Filed: Jan. 24, 2014

Related U.S. Application Data
(60) Provisional application No. 61/756,915, filed on Jan. 25, 2013.
(60) Provisional application No. 61/930,179, filed on Jan. 22, 2014.

(51) Int. Cl. G06Q 50/00; G06Q 10/10

(52) U.S. Cl. CPC G06Q 50/01; G06Q 10/1093
USPC 705/319

(57) ABSTRACT

Techniques are provided for synchronizing a plurality of client wearable elements based on an event. Systems may include a social control module that produces synchronization signal(s) based on an event, and a social communication module that transmits the synchronization signal(s) to the one or more social clients. Systems may also include a social receiver module that receives synchronization signal(s) and sensory stimulation modules that actuate based on stimulation signal(s). A stimulation schedule module generates the stimulation signal(s) based at least in part on the at least one synchronization signal. Wearable elements retain at least a portion of the modules described. Various other aspects are directed toward feedback collection and use, sequencing signals, relationship management, client identities, and other related aspects.

### CROSS-REFERENCE TO RELATED APPLICATIONS

This U.S. patent application is a continuation of and claims the benefit of U.S. provisional patent application 61/756,915 filed on Jan. 25, 2013, and U.S. provisional patent application 61/930,179 filed on Jan. 22, 2014, which are incorporated herein by reference in their entirety.

### BACKGROUND

This innovation relates in general to synchronization of electronic devices. More particularly, this innovation relates to synchronization of wearable devices to facilitate collaborative interaction between an event's organizers and participants hierarchically and laterally.

### SUMMARY

This innovation generally relates to a system including a social receiver module that receives a synchronization signal based at least in part on a group event, one or more sensory stimulation modules that actuate based on a stimulation signal, a stimulation schedule module that generates the stimulation signal based at least in part on the synchronization signal, and one or more wearable elements that retain at least a portion of the social receiver module, the one or more sensory stimulation modules, and/or the stimulation schedule module.

An additional embodiment provides a system which includes a social control module that produces one or more synchronization signals based on a group event, the one or more synchronization signals include stimulation information that actuates sensory stimulus modules and a social communication module that transmits the one or more synchronization signals to one or more social clients associated with the sensory stimulus modules.

Another embodiment provides a system having a control section for administering synchronization of a plurality of wearable social devices and an execution section for completing synchronized actions with the plurality of wearable social devices. There is an identity module that associates at least one client identifier with one or more social clients, a social control module of the control section that produces at least one synchronization signal based on a group event and the at least one client identifier, a social communication module of the control section that transmits the at least one synchronization signal to the one or more social clients associated with the sensory stimulus modules, a social receiver module of the execution section that receives the at least one synchronization signal, one or more sensory stimulation modules of the execution section that actuate based on at least one stimulation signal, a stimulation schedule module that generates the at least one stimulation signal based at least in part on the at least one synchronization signal, and one or more wearable elements of the execution section that retain at least a portion of the social receiver module, the one or more sensory stimulation modules, and/or the stimulation schedule module, wherein the one or more wearable elements are associated with the one or more social clients.

Various aspects will become apparent to those skilled in the art from the following detailed description and the accompanying drawings.

### BRIEF DESCRIPTION OF THE DRAWINGS

FIG. 1 is an example illustration of a system for facilitating interaction between a control section and an execution section of a social event.

FIG. 2 is an example illustration of a system having a control section for administration of interaction in a social event.

FIG. 3 is an example illustration of distributed or additional components related to interaction between a control section and an execution section of a social event.

FIG. 4 is an example illustration of a system having an execution section for performing interactions in a social event.

Appendices 1-23 illustrate various aspects of systems and methods described herein.

### DETAILED DESCRIPTION

The innovation is now described in various aspects. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation. While one or more drawings accompanying this detailed description may or may not be discussed, all aspects from the drawings are wholly incorporated herein, as are any other appendices or supplemental materials. Where materials provided herewith conflict regarding scope or spirit of the subject innovation, such conflicting aspects should first be read as alternative or complementary embodiments, and if no such reading is possible, the broader reading shall apply.

As used in this application, the terms “component”, “system”, and “module” are, unless otherwise expressly noted or necessary, intended to refer to a computer-related entity, either hardware, a combination of hardware and software, software, or software in execution. For example, a component or module can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Specific modules are described throughout this disclosure and relied upon in systems and methods herein. Modules are generally capable of one or more of receiving, sending, and/or transforming data electronically. In some instances, handling of information can include energizing or switching related to another module (e.g., powering, controlling, or timing one or more light emitting diodes). Various complex functions can also be performed, such as receiving and processing feedback information, querying a database, and responding based on the feedback and database information.

Generally, communications modules are modules of one or more devices, systems, or subsystems capable of communicating by wired or wireless means with other devices. Such modules are not restricted to communicate exclusively with other devices, and may also communicate or facilitate communication between components or subsystems of which they are a part. Communication modules can use, for example, various proprietary technologies or developed standards (e.g., universal serial bus, Bluetooth, WiFi, infrared, near field communication, radio frequency identification, optical communications, electromagnetic communication, personal area networks, combinations thereof, and others). In embodiments, specific standards or variants may be required to meet constraints such as connectivity, sufficient power, or permit operation of specific aspects herein. For example, Bluetooth Low Energy (BLE) permits easier device pairing than earlier technologies with regard to subscription and sharing. In another example, a universal serial bus (USB) connected component may require a current (e.g., greater than 0.5 amp, greater than 2 amps, and others) which cannot be provided by early standards of the technology, necessitating a modified or late standard (e.g., USB 2.0, USB 3.0).

Communication modules can include or be operatively coupled with one or more antennas, or arrays of antennas, for both broadcast and reception. The arrays can be configured to receive not only signals, but include or be coupled with additional hardware or software to determine signal characteristics. In such embodiments, antenna arrays or associated components can determine information related to sending and receiving units. For example, signal strength calculations, power or storage calculations (e.g., voltage, current, battery condition), triangulation (distance, direction, or both), altitude calculation, counting (e.g., of devices in communication), and other information can be discovered and/or provided using communication modules and associated components (including antenna arrays). Further, other information such as environmental conditions, interference, and so forth can be gathered similarly.

In another example of terms referring to multiple components or embodiments thereof, the term “sensory stimulation module” is intended to describe any component or device configured to be perceived by a human sense. Such devices are typically capable of being actuated by an electrical signal. However, systems and methods herein may also employ one or more sensory stimulation modules which do not require such actuation (e.g., always-on).

In one or more embodiments, a sensory stimulation module can be at least partially directed to visual stimulation, and can include one or more of lighting (light emitting diodes, gas-discharge lights, filament-based lighting, et cetera, powered on/off or strobed), video or image displays (light-emitting diode displays, liquid crystal displays, plasma displays, other monochromatic or color mobile displays), reflectors, smart materials (e.g., materials which change color or transparency based on stimulus or environment), and others.

In one or more embodiments, a sensory stimulation module can be at least partially directed to touch stimulation, and can include one or more of haptic technology or other vibrating component, heating or cooling components, components capable of generating air pressure or vacuum, components which apply an electrical charge to a user or surface, and others.

In one or more embodiments, a sensory stimulation module can be at least partially directed to auditory stimulation, and can include one or more of speakers (e.g., reproducing an entire audio signal, reproducing a portion or frequency band of an audio signal, producing a complementary or discordant audio signal, producing an unrelated audio signal), or other components producing sound (e.g., percussive component, buzzing component, whistling component). In at least one embodiment, an auditory sensory stimulation module can be personal to a user (e.g., only perceived by the user) due to the direction or fashion in which the sound is emitted or produced, or based on cancellation of the sound waves by active and/or passive noise control measures.

In one or more embodiments, a sensory stimulation module can be at least partially directed to taste or scent stimulation, and can include one or more of modules which emit or capture various matter to provide or create the impression of various tastes or smells to one or more users.

Sensory stimulation modules need not be dedicated exclusively to one sense, and combination sensors are embraced under the disclosures herein. For example, a buzzer may provide both auditory and haptic feedback. Further, specialized multi-function sensory feedback modules may be provided to produce two or more forms of sensory stimulation (e.g., sight, sound, touch, smell, taste), or multiple forms of the same sensory stimulation (e.g., heating and cooling, pushing and pulling, different tastes or smells, different frequencies or amplitudes).

While sensory stimulation modules herein are generally associated with a single client, and configured to be wearable by a user, complementary or alternative embodiments permit various components remote from the user can be sensory stimulation components, or used in conjunction therewith. For example, remote speakers, smell or taste emission devices placed in a venue, heating or cooling elements, various emitting elements (water sprinklers, fog machines, foam machines, et cetera), and other devices which stimulate the senses of event participants can be integrated with components herein, and actuated or controlled based on feedback from components herein, without departing from the scope or spirit of the innovation. If sensory stimulation modules can be perceived as one “output” provided to one or more clients, there can also be “inputs.” While some inputs may be provided by a controller, administrator, or otherwise be broadcast or provided to a global group or sub-elements thereof, feedback from the global group, sub-elements, and individuals can be collected as feedback and used as input to change or supplement outputs and other system aspects. In this regard, feedback modules, and collection devices associated therewith (e.g., sensors) can be integrated with various components provided. Various feedback modules or sensors can include (but are not limited to) feedback modules designed to discover or collect information related to client and client systems, a user of the client, groups of clients or users, and one or more environments associated with components of the system. For example, feedback modules or sensors associated therewith can include gyroscopes, accelerometers, compasses, barometers, global positioning system (GPS) receivers, sensors utilizing relative or local location techniques (e.g., triangulation, signal strength detection, proximity sensors, radio frequency identification and known-range fields, and others), thermometers, motion sensors, heart rate monitors, respiratory rate monitors, microphones or other sound detection equipment, perspiration detectors, eye movement detectors, brain activity monitors, blood pressure monitors, chemical detectors, hygrometers, stopwatches, counters, cameras, and others. Further, raw data collected can be processed (using, e.g., machine vision techniques such as blob detection, image processing, edge finding, segmentation, pattern recognition, neural net algorithms, and other image processing techniques) to provide conclusions or inferences as to the significance or context of feedback received.

Modules, including sensory stimulation modules and feedback modules, can be flexible, distributed, and/or discontinuous. For example, various sensors, circuits, and devices can be built on flexible materials using boards employing flexibly wired or wireless communication between components, allowing for their arrangement in apparatuses of irregular or changeable shape.

Further, modules herein can generally be associated with shared or dedicated storage and processing means for purposes of their function. For example, various hardware, software, or combinations thereof can be utilized to perform energization, de-energization, and timing thereof in relation to provisioning of stimulation. In another example, feedback modules can be operatively coupled with sufficient storage to record feedback collected, and communication modules can in turn be associated with media that is at least readable to facilitate storage of information received and/or transmitted.

As used herein, “devices”, “groups of devices”, or similar language is intended not (or not only) to refer to one particular device or a heterogeneous group of devices, but can rather refer to a device or group of devices sharing at least some common capability. Devices can be comprised of different hardware, software, and other components. A device as used can be any piece of electronics capable of participating in systems and methods set forth herein. For example, a device can be a cellular telephone (e.g., smart phone) with one or more “apps” (e.g., mobile applications) providing programming that leverages the telephone's existing capabilities to participate in one or more aspects herein.

In another example, dedicated devices designed at least in part with the intent of participating in systems and methods herein can be employed. While some embodiments can include devices employing transceivers enabling wireless communication and/or sensors enabling environmental feedback, such should not be read to necessarily prevent the participation of electronics that lack or do not expressly include such aspects. For example, a device can be prepared in advance to participate in aspects herein (e.g., user loads “tracks” or “set”, device is pre-programmed, device stores information on local memory, and other solutions) and manually triggered by a device user to synchronize or execute. At least in this way, a device without wireless reception and/or sensor capabilities can participate in aspects herein or be a member of a group of devices where members of such group include other devices that have wireless reception (and/or transmission) and/or sensor capabilities. In another example, a user can “chain” devices individually lacking reception/sensor capabilities to a local device (e.g., the user's telephone) to facilitate interaction. Except where expressly described, there is no limit to a number of devices interacting or grouped together, and no limit to a number of devices an individual user can employ. For example, devices need not adhere to any one-to-one device-to-user ratio, and users can potentially possess and/or wear a plethora of devices, both dedicated (e.g., “concert gloves” designed for use in interactive entertainment) and leveraged (e.g., Android® tablet with one or more apps installed).

Such dedicated devices can be, in some embodiments, wearable elements. As used herein, a “wearable” element or device is one that is integrated into an item of clothing or accessory. For example, a wearable element, structure, or item can be a clothing item with a receiver and sensory stimulation module (and any other necessary components, such as a battery) integrated therein. Examples of clothing can include, but are not limited to, footwear (e.g., shoes, sandals, socks, boots), legwear (e.g., pants, shorts, stockings, skirts), underwear (e.g., briefs, panties, thongs, boxers, bras, undershirts), tops (e.g., shirts, blouses, camisoles), outerwear (e.g., jackets, coats, blazers, vests, sweatshirts, robes), headwear (e.g., hats, caps, earmuffs), handwear (e.g., gloves, mittens), and/or other items worn other than accessories. Accessories can include, but are not limited to, jewelry (e.g., bracelet, anklet, ring on any portion of the body, bands, piercings on any portion of the body, necklaces, pendants, charms), glasses, decorative headwear (e.g., crown, tiara, halo), bags or holders (e.g., backpack, fanny pack, purse), functional items (e.g., headphones, mobile devices), belts, costume items, and others.

As used herein, “tracks” can refer to information provided to one or more devices for processing. For example, a track can include (but is not limited to) action information for one or more devices or components based on synchronization with entertainment. A track can also include one or more actions for training or behavioral guidance. Tracks can be organized into groups, which are termed “sets” in some instances. Further depth to the understanding of tracks and sets will become apparent to those skilled in the art upon study of the innovations herein.

In embodiments, the innovation can include a group of devices including wearable electronics. The wearable electronics can receive and contribute to one or more synchronization signals, as well as supplemental social signals, to share common stimuli related to an event, as well as influence the event itself as perceived by at least a subset of other users or clients. The synchronization signals can, in embodiments, define or be defined by tracks or sets. While tracks and sets are generally used as pre-sequenced arrangements, whereas the synchronization signal is a real-time, dynamic broadcast, these terms are employed flexibly and will be appreciated in various contexts by one of ordinary skill in the art.

While various modules or components are shown associated with particular sections, groups, or locations, it is understood that the illustrated embodiments are intended only to show a subset of workable alternatives rather than an exhaustive depiction of all possible arrangements. Further, not all elements need be included, and additional elements may be omitted or added to accommodate additional, remove existing, or combine aspects depicted, without departing from the scope or spirit of the innovation. Elements described as distributed may be wholly stored or constructed in a single location, and elements shown as static or of known location may be distributed or oriented in fashions not pictured.

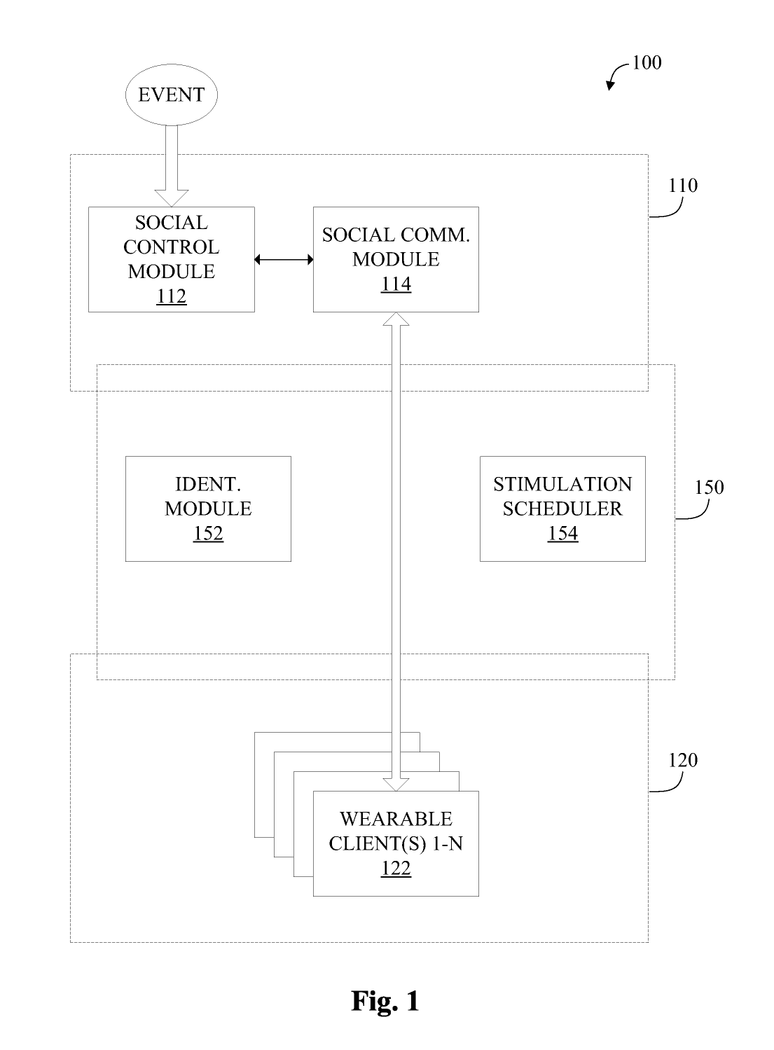

Turning now to the figures, FIG. 1 illustrates an example of a system 100 for facilitating interaction between a control section 110 and an execution section 120 of a social event. Generally, the control section 110 administers synchronization of a plurality of wearable social devices. The control section can include a social control module 112 that produces at least one synchronization signal based on a group event and at least one client identifier. A social communication module 114 then transmits the at least one synchronization signal to one or more social clients 122 associated with the sensory stimulus modules.

As discussed above, the synchronization signal(s) can be based on tracks, sets, or other input. In embodiments, the synchronization signal(s) can directly actuate one or more sensory stimulation modules, which can be integrated in wearable elements associated with clients 122. Such synchronization signal is based on combinations of live and pre-programmed inputs, and can be associated with an event as shown in FIG. 1. For example, the beat, tempo, tone, intensity, or other characteristics of an audio signal (which can, but need not, include music) can be expressed through various sequences or relative outputs (e.g., signal oscillates with beat, signal changes with amplitude or dominant frequency, et cetera) which are mapped, translated, or coded into a signal that can be received and interpreted for use (e.g., selective actuation of sensory stimulation modules) by one or more devices or components. In an example of such technology, various visualization techniques are known for audio signals, enabling display of the signals in forms permitting simple interpretation and study of the signal (e.g., equalizer scope, oscilloscope) as well as forms intended for aesthetic or artistic expression tied to the music (e.g., media player visualization plug-ins).

While aspects herein are described in terms of music, it is understood by those skilled in the art that other occurrences or information can be mathematically expressed and/or encoded for the production of similar synchronization signals. In some embodiments, a visual performance can be synchronized by measuring, for example, color, relative and absolute movement, speed, acceleration, and other variables detectable from a video signal of the visual performance.

The synchronization signal is received by the execution section 120 which includes one or more clients 122. The clients 122 can be associated with a plurality of wearable social devices, at least a portion of which can receive the synchronization signal. The clients 122 can include a social receiver module that receives the synchronization signal. The execution section also includes one or more sensory stimulation modules that actuate based on a stimulation signal.

In embodiments, the synchronization signal can be the stimulation signal. However, in order to permit broad user preferences and accommodate various distinct types of wearable elements and sensory stimulation modules, a stimulation scheduler 154 can interpret and/or process the synchronization signal for specific use by one or more clients sharing common preferences and/or hardware. For example, the synchronization signal can be converted into another format, and/or portions can be added or redacted, to permit use by the sensory stimulation modules (and/or other components). Thus, the stimulation scheduler 154 can generate the at least one stimulation signal based at least in part on the at least one synchronization signal.

In addition, the system can also include an identity module that associates at least one client identifier with one or more social clients. In at least one embodiment, all users share one or more global synchronization signals, and if more than one signal exists, default rules (e.g., location, strongest signal) may be used to select the appropriate signal. However, in embodiments, user identity can be used to permit provisioning, subscription, and/or access to a synchronization signal not globally available to all users in range. In such fashions, client identifiers allow clients to be organized and/or individually identified in groups that are a subset of the total community. Further, by enabling individual identification, personalized interactions can occur between individuals or groups.

At least a portion of the social receiver module and/or the one or more memory stimulation modules can be retained on one or more wearable elements of the execution section to facilitate mobile, social integration.

While some embodiments can broadcast synchronization signal(s) via wireless data transfer, nothing herein should preclude the use of devices manually coordinated or actuated. For example, a user can manually provide a memory with information containing the synchronization signal (e.g., track arrangement, sets) coordinate with the event locally where no communication can be established. Further, in embodiments, software or hardware of devices associated with clients 122 can locally modify an existing signal (e.g., speed up or slow down to match beat) to permit participation even where no signals can be exchanged beyond the individual client.

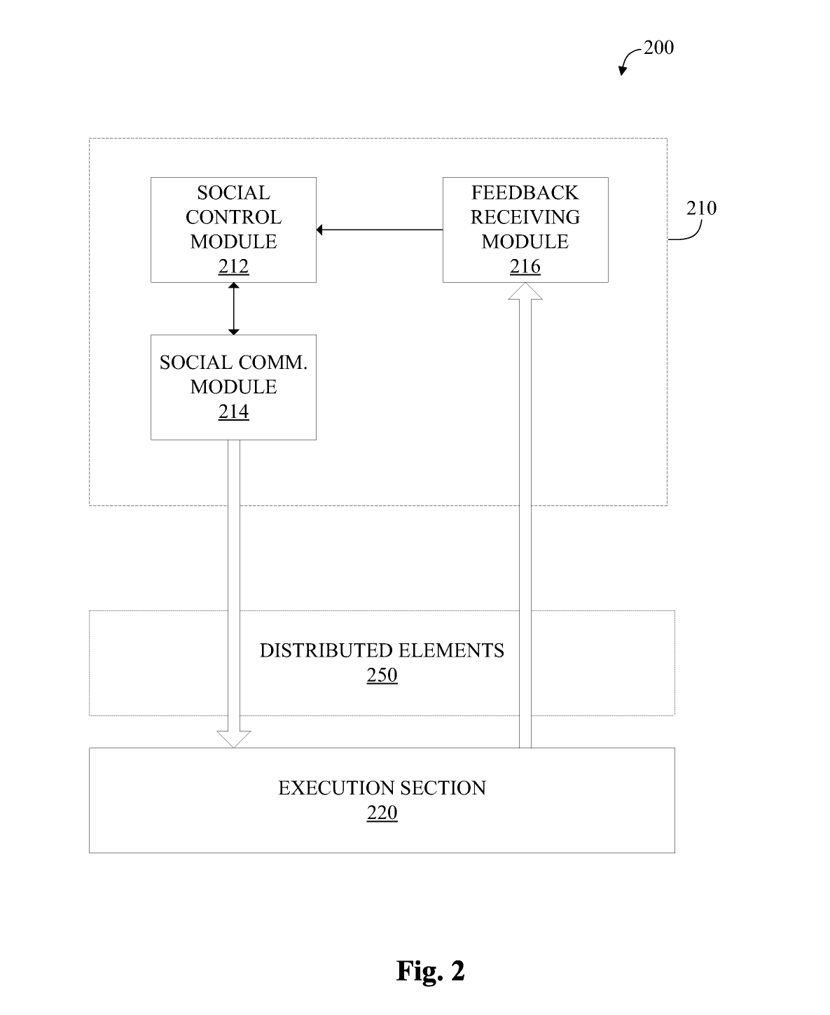

Turning now to FIG. 2 illustrated is an example of a system 200 having a control section 210 for administration of interaction in a social event. Control section 210 includes a social control module 212 and a social communication module 214, which are generally similar to similarly-termed modules herein.

In system 200, control section 210 further includes feedback receiving module 216, which can receive feedback from at least execution section 220. Feedback receiving module 216 receives feedback data from one or more feedback tracking modules, which can be processed and/or provided to social control module 212. Based on the feedback received, social control module 212 can change the synchronization signal(s) (e.g., modify existing, delete existing, add new, multiples or combinations of similar actions) to facilitate interaction between clients and the tracks or sets associated with the event(s).

In embodiments, command or collaborative techniques described herein can be enabled using feedback and subsequent synchronization signals broadcast to devices. Synchronization signals in original or feedback-modified forms can coordinate function of the devices, both on group and individual levels, and can be developed and promulgated in real-time (e.g., in the case of software instruction broadcast, where the software instruction is transmitted as it is being created, and is executed immediately on receipt or during an ongoing synchronized session rather than stored for later use). In embodiments, “pre-tracked” information can be broadcast (e.g., track developed in advance and stored, track developed in advance for broadcast at a later time), and such can be provided before feedback is available or selected based on the feedback received.

Various hybrids of real-time and pre-tracked will be appreciated by those skilled in the art. For example, a primary pre-tracked track can be provided in advance to participants. This is executed during the performance. Later in the performance, another pre-tracked track is promulgated in real-time. Thus, it is a real-time update for participants, but the organizers still executed some elements of pre-tracking. Still later in the performance, one or more organizers may choose to interject additional improvisation, and begin developing a new track in real-time, which is transmitted to the participants in real-time as well.

Thus, interaction between execution section 220 and control section 210 can occur through feedback received via feedback receiving module 216. Feedback as described herein can be analyzed to determine, for example, favorable or unfavorable environmental factors, crowd enthusiasm or activity, system load or faults, and other information. Appropriate feedback can be timed for coordination with one or more aspects related to the synchronization signal or associated environment (e.g., lighting, sound, other effects). In embodiments, the responses can include changes to aspects related to the synchronization signal or associated event(s). For example, changes can be committed to lighting (e.g., on light emitting diodes associated by a client receiving the synchronization signal, on external lighting around a user, on a spotlight above a group of users, and so forth), sound (e.g., user-worn speaker emits sound, speaker on user's iPhone® stops emitting sound, audio balance for venue sound reinforcement changes with respect to a group of users, and so forth), mechanical sensory outputs (e.g., phone vibrates, wearable devices pulse, and so forth), and others. While a baseline synchronization signal may be provided for one or more of these aspects, various algorithms can be utilized to modify their use or involvement based on feedback.

The timing or manner in which feedback is collected can be timed or triggered based on various parameters. For example, feedback may be dependent on user position (e.g., in a venue, at the venue bar, in front of a particular stage in a multi-stage venue, in proximity of other users, in an absolute proximity such as measured by global positioning systems or cellular triangulation, and so forth). Alternatively, feedback can be timed or triggered based on event content (e.g., music, speaking, scene or act, action of players, movement of equipment, and so forth).

In embodiments involving real-time collaborative use through feedback, various techniques for blending and de-conflicting input and/or tracking from various users can be performed. In embodiments, the popularity of a particular client's or user's tracks (e.g., likes, number of times downloaded or stored, number of participants reached, and others), social media feedback (e.g., number of friends or groups on a social network and so forth), enhanced authority (e.g., administrative user selected by organizer), and others can be used in various selection, weighting and/or combination schemes.

Both before and after collection and analysis of feedback, control section 210 can send information (including a synchronization signal) to at least execution section 220. In at least one embodiment, control section 210 may exchange or transform data or signals by operation with distributed elements 250.

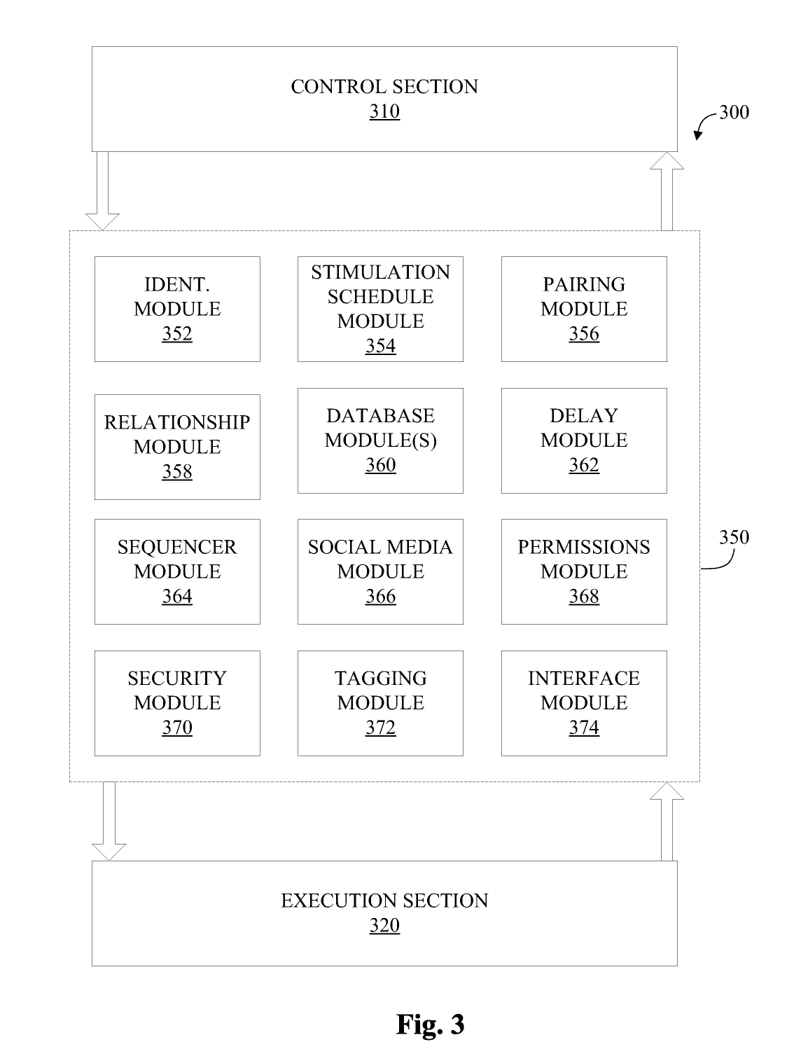

Turning now to FIG. 3, illustrated is an example of a system 300 including distributed or additional components related to interaction between a control section and an execution section of a social event. Such components may wholly or in part be located with the control section 310, execution section 320, and/or any other location.

Similar to aspects discussed above, identity module 352 can associate at least one client identifier with at least one of the one or more wearable elements. In embodiments, two or more identifiers can be associated with a single wearable element or related group of wearable elements, such as when both temporary and permanent identifiers are employed.

While it is desirable to fixedly identify particular users to retain their settings, the social environment in which system 300 exists can mitigate concerns regarding privacy or security by issuing temporary identifiers and associating them with one or more clients. The temporary identifiers can be time stamped to allow external components to determine if they are expired, self-destruct or delete upon expiration, or persist in a dynamic fashion wherein a temporary identifier changes over time or based on interaction. In embodiments, a real-time clock (e.g., coordinated by GPS, coordinated by synchronization signals, or others) is used to administer one or more temporary identifiers. Where temporary identifiers are rendered obsolete or removed, updated or new temporary identifiers can be provided.

Accordingly, identity module 352 can, alone or in combination with other modules, assign or receive permanent identifiers associated with clients and/or related wearable elements. Further, identity module 352 can associate temporary identifiers with clients and/or related wearable elements.

Aspects related to stimulation schedule module 354 are also discussed generally above. Stimulation schedule module 354 can receive the synchronization signal and other information to determine when sensory stimulation modules are actuated. In embodiments, stimulation schedule module can harmonize and deconflict multiple synchronization (or other) signals. Further, stimulation schedule module 354 may receive future synchronization signal information, or render predictions of the same, to plan additional actuation of sensory stimulation modules before the need for a real-time determination arises.

Pairing module 356 can be utilized to manage connections between the various devices involved in system 300. For example, various devices of the control section(s) and execution section(s) may be required to subscribe, authenticate, or pair to properly exchange information. Pairing module 356 can facilitate determinations of compatibility, determination of parameters, storage of authentication or approval information (alone or in combination with other modules such as database module(s) 360), and effect pairing or connection of various devices. For example, a pairing module 356 associated with a first client can automatically pair with a global synchronization signal from the control section associated with an event administrator, but await approval for pairing with other clients. While such embodiments suggest pairing module 356 be individually associated with each client, those of ordinary skill in the art will further appreciate how a single pairing module can be leveraged or accessed by at least a group of relevant clients.

Relationship module 358 facilitates additional social aspects of system 300. Relationship module 358 identifies existing and prospective relationships, and can assist reminders and decision making with respect to relationships to ensure their identification, enjoyment and growth. For example, permissions can be granted to other clients identified as relationships of particular classifications; software can be employed to track and improve relationships by making recommending various behavior and/or physical interaction between users; and prospective relationships can be identified and suggested based on shared information.

Relationship module 358 can manage, monitor, and review relationships and interactions with other people, businesses, or any other entity. By monitoring aspects (e.g., detected physical) and social interactions (e.g., provided manually by user, detected or inferred using sensor input, inferred based on information such as a calendar including birthdays or events, inferred or developed using network-based social interaction such as messaging or collaborative spaces, and others) a user can seek information, improvement or advice related to interpersonal exchange.

In particular embodiments, relationship module 358 can have functionality to guide or provide templates for behavioral responses in social situations (e.g., to improve relationships). Templates can be based on an individual user's behavior and outcomes, or those of the entire community of users associated with wearable devices and participation in system 300. Templates can be based on classification techniques, whereby relationships and actions can both be solved in terms of classifications such that algorithms applied can automatically take action, suggest action, issue reminders, et cetera. Various constraints, such as budget (discretionary funds available for relationships), time (calendars of parties to relationship), space (location of parties to relationship, location of possible relationship activities), relationship priority (close friend versus remote prospective friend), species (human, animal, device, concept, object, object properties) can be considered with respect to application of templates for relationship management.

In embodiments, comparative and/or statistical methods can be employed with respect to two or more users to find similarities (e.g., like the same band), differences (e.g., one likes food that another dislikes), interests (e.g., participate in rock climbing, working in a particular field), biographic or demographic information (e.g., age, birthday, birthplace, family size, hometown), and other information to facilitate interaction. Further, common “tags” (e.g., links in social media through participation, attendance, multimedia presence, et cetera) can be used to identify relationship priority (or rating), type of relationship, or the strength of prospective relationships.

While templates are described herein with respect to relationships, system 300 can provide templates for other activities or interests based on existing information and/or evaluated performance from modeling, other user data, experts, or any relevant source. In this way, other training templates can be involved. Training templates can be created, compared, applied, refined, et cetera, to assist a user with not only social or interactive aspects, but also various other skills that can be practiced (e.g., dancing as it pertains to a group event or particular synchronization signal). Further, templates can be signaled or enforced by modifying a synchronization signal (or generating/accessing a different signal) to provide sensory feedback based on adherence or deviation from the template. Physical training, task practice, situational awareness, and various other aspects can be planned by templates and enforced using sensory feedback.

Goals can be tracked by relationship module 358 (or related training components) to assist with planning of relationship management beyond a single event or decision. Effectiveness and other qualities or effects can be observed or evaluated by the client, the relationship partner, or third parties. Further, various algorithms can be employed to evaluate priority/closeness and or other qualities or outcomes related to relationship recording and tracking. A plurality of relationships can be tracked simultaneously. Further, relationship actions (e.g., reserving a table, ordering a present, sending a communication) may be automated or prompted, subject to identified or detected constraints (e.g., available budget). Such constraints can also be used to improve and manage relationships at minimal cost (monetary and otherwise) or according to efficient cost planning. Relationship module 358 can additionally manage the schedules of two or more parties to facilitate deconfliction of relationship activity.

As suggested here or elsewhere, data is stored for use with system 300. Signals, tracks, sets, identifiers, templates, relationship information, and other information can be stored in database module(s) 360. Further, additional modules not discussed herein but provided in incorporated disclosures or known to those of ordinary skill in the art may be at least in part stored in and/or executed from database module(s) 360.

In embodiments, clients seeking to share information (e.g., identity, previously-executed or custom sets or tracks, et cetera) can do so using database module(s) 360. For example, the tracked information can be provided to database module(s) 360 from a user's phone, either based on a user download or installation, and/or based on permissions or actions set by the user. In embodiments, an authorized programmer can provide one or more tracks, portions of tracks, or additional supplemental information to database module(s) 360 in real-time during an event, in advance thereof, or at any time. In embodiments, the authorized programmer is responsible for an individual, group of people, location or area, et cetera, and can perform at least some function associated with one or more control section(s) 310. In embodiments, every user is an authorized programmer in this context, and a collaborative environment, both real-time and pre-tracked, can exist in or around one or more events. In this fashion, users can share tracks or other information. Tracks and other information can be shared expressly or through permissions to individuals, groups, or other identifiable entities, or can be broadcast to the global social community.

In still further alternative or complementary embodiments, database module(s) 360 can be used to store user preferences or settings. For example, do not disturb times, permissions, modes of operation, power levels, and other information can be stored to prevent a user or client from re-setting such aspects during each use or event.

Delay module 362 serves as a timing component which can delay presenting of content in order to permit synchronization with the synchronization signal. Because there is a small amount of time associated with propagation, processing, and execution of the synchronization signal, a delay may be imposed to ensure all components are properly synched before actuation occurs with the happenings of the group event. Further, in embodiments, distributed events may occur over large geographic areas (e.g., remote music events), and can be synchronized locally or at all live locations using delay module 362.

Sequencer module 364 allows clients to create and mix their own tracks and sets, or create related synchronization signals, based on recorded activity and/or deliberate programming. For example, one or more users can record physical interactions using sequencer module 364 to determine or supplement information provided with tracks. In embodiments, a user can determine information related to at least one track without external influence, and can create a track or portions thereof using sequencer module 364 to be reused by the user. In such embodiments, the user can share the track for either individual or group use as described above. In embodiments, one or more users can record a stimulus or create environmental interaction that serves as a basis for one or more other users' interactions using sequencer module 364.

In this way, a social track development scheme can be enabled such that a plurality of users can not only respond to one or more “directors,” but can also organically develop tracks in conjunction with one-another on-the-fly or through shared evolution. Tracks can exist in multiple versions, and in embodiments users can replace and modify versions while retaining access to previous versions. In embodiments, a director or group of administrators manages the tracks and the users commit to participate in accordance with the director's or administrative group's track decisions. Alternative, complementary, and/or hybrid techniques will be appreciated by those skilled in the art (e.g., different permission levels for portions of a track, such as a track where a director promulgates a lighting scheme that is part of a track, an algorithm resolves a sound management scheme that is part of the track, and users collectively develop a mechanical interaction scheme involving vibration or pulsing that is also part of the track, et cetera). Such aspects can be sequenced by participants or an administrator associated with control section 310 at least in part using sequencer module 364.

In an example of aspects to which tracks can be sequenced, various music or musical performance can be utilized. Tracks can be developed to interact with music (e.g., with software). In the same way a performance includes multiple songs, one or more tracks can be developed to accompany a performance. In a non-limiting example, a “DJ” (or master of ceremonies/MC) can “mix” a plurality of songs, where each song has a track associated. Associated tracks can be manually sequenced by the DJ, manually sequenced by the user, or sequenced by computer algorithms that analyze qualities of the song and/or environment in which the song is played. In embodiments employing computer algorithms to sequence tracks along with audio information, a plurality of different tracks can be produced based on the same portion of audio information. For example, track fingerprinting algorithms focusing on data (such as that represented by sound waves or spectrograms) or aspects thereof (e.g. “peaks” or “valleys” in audio information) can identify one or more songs, and thereafter create one or more tracks to accompany each identified song (with the scope of such techniques embracing two or more tracks for the same identified song). In alternative or complementary embodiments, statistical analysis techniques can be employed to identify music or other information with which a track is associated. In embodiments, the track produced or utilized can be dependent on the environment (e.g., public, private, headphones, speakers, live show, recording, and others).

Continuing with earlier non-limiting examples related to sequencer module 364, a DJ mixes songs. Mixing can include, for example, combining two or more songs in a seamless manner such as to avoid a break in the music, including continuity in the beat, tempo and phrasing of the songs that are simultaneously audible. In embodiments, as one song is layered atop another to facilitate a transition between songs, the track associated with user devices can change. In another embodiment, an MC speaks or sings over the DJ, causing a change in one or more tracks. This change can include switching to an entirely new track, a blending or combination of tracks associated with both songs, and/or the introduction of a transitional track not associated with either song. In embodiments, two tracks can be blended by addition (e.g., all aspects from both tracks in effect), subtraction (e.g., only those portions of the first track not in the second track in effect), amalgamation (e.g., select portions of each track to retain based on various criteria), and others. Where tracks are blended by amalgamation, criteria can include selecting aspects of each track that are most significant, select portions of both tracks that are de-conflicted based on total resource use (e.g., do not want all light emitting diodes lit up for the entire transition so select portions of each track that do not overlap while according with music synchronization), and so forth. The DJ can use various software to modify the tracks real-time. In embodiments, users can provide feedback to the DJ, actively or passively. For example, active feedback can include users “liking” a portion of the performance or submitting text and/or audiovisual content to the DJ. In embodiments, voting can be enabled using appropriately capable devices. With regard to passive feedback, the DJ can be notified of user track development, changes in user movement, changes in noise level, and so forth, to facilitate understanding of a crowd's reaction to his action. In such aspects, both the DJ and users can use sequencer module 364 to influence one another in both hierarchical and peer fashions, as well as modify their own personal experiences. Put another way, in embodiments, each user can be a DJ/MC to themselves or other users, and a plurality of sub-events can occur simultaneously (e.g., in which tracks are created and shared).

Moving beyond the above non-limiting example, an event coordinator can sequence tracks using sequencer module 364 as part of a performance or activity, or for training purposes. The tracks can be created live, in advance, or combinations thereof. The devices (and/or services) can integrate with other communication devices (e.g., a user's mobile phone). The devices can additionally integrate with installed or environmental devices (e.g., lighting, sound, fog machines, and so forth for the room or area used with the event or group).

Sequencer module 364 can be used to query database module(s) 360 to search for preexisting tracks or sets for modification, and can add or delete existing tracks, thereby managing a repository of sequenced content.

System 300 can also include a social media module 366. Social media module 366 leverages participation of clients associated with social media accounts (e.g., as identified using identifiers from identity module 352) and look to their respective networks and interactions to connect clients or modify their activity via a synchronization signal.

Near field communication can be employed to locate one or more users and send or receive data in embodiments directed to social aspects as well as the entertainment, performance and/or training coordination described supra. In alternative and/or complementary embodiments, other techniques (e.g., triangulation, optical recognition, other information transfer means) can be employed over a device network. In embodiments, a user can target one or more other users with who to interact based on social media connections or suggestions. In embodiments, users can send and/or receive public information from other users. Some embodiments can facilitate sending and receiving public or personal contact information (e.g., to introduce themselves). Various groups and accompanying permission levels can be defined to facilitate management of what is sent and received between users.

As this suggests, network integration can occur with techniques herein. For example, social graphs can be created or leveraged in view of user networks associated with devices or based on preexisting social networks. Aspects related to relationship management or social behavior can have, for example, independent gift-buying capabilities or be linked to other gift-buying systems. In embodiments, gift-buying capabilities can be linked to social graphs or networks, calendars, text and call logs, messaging logs, and other aspects from which social information can be discovered or inferred. Various other techniques beyond gift-buying that employ such information will be appreciated by those skilled in the art.

Continuing, system 300 can include a permissions module 368. Permissions module 368 can define devices or synchronization signals which can be automatically subscribed and/or paired, manually subscribed and/or paired, and which are not to be subscribed or paired. In this regard, permissions module 368 can accomplish registration both of new wearable elements/devices among one another, and of groups of wearable elements/devices to other groups or to one or more control sections 310. Further, permissions module 368 can permit a client to delegate permissions to other users or for remote use, such that different synchronization signals or other information can be provided to wearable elements or other devices associated with the delegating client from the permitted sources. Similar to facilitating delegation of device permissions, permissions module 368 can also manage access to various content (e.g., stored on client wearable elements or associated devices, stored in database module(s) 360) for sharing or broadcast.

Permissions module 368 can restrict access to content in various ways. In some non-limiting examples, content may be restricted according to a requester classification or identity; content may require notification to an administrator before access is granted; content requests may be accompanied by information relating to or messages from the requester; and a request for content may be granted or denied based on a group to which the requester belongs. Where a particular requester does not have specific permissions or the content is unavailable, alternative content may be identified or provided locally or remotely.

In some embodiments, content or other permissions managed by permissions module 368 may be collaboratively developed. For example, users or groups may vote or select a group delegation to define permissions for one or more clients.

Security module 370 can provide additional security beyond that of permissions module 368. For example, various personal identification numbers, passwords, social media information, permanent identifiers, and other potentially sensitive information can be handled by security module 370. Security module 370 can interrogate client identifiers and associated information to verify identities, and can further provide encryption and other safeguards against misappropriation of sensitive information over the air or in other contexts. In this regard, various techniques for security, authentication, validation, and permission can be implemented to prevent unauthorized access to wearable elements, undesirable manipulation of synchronization signal(s), unintended track or set dissemination, and/or other abuse of system 300. Security module 370 can implement various proxies and logical containers to prevent unauthorized access to aspects of system 300.

Tagging module 372 interacts both with wearable elements of execution section 320 and other modules (e.g., social media module, relationship module) to allow a party to tag another party. Consent for tagging can be managed according to permissions module 368. As discussed above, tags can include, but are not limited to, links in social media through participation, attendance, multimedia presence, and other data-based artifacts of common or group interaction. Tags can in turn be leveraged by other components for use as described herein.

Interface module 374 provides interactivity between clients of execution section 320 and the various components described above. Interface module 374 can be one or more of mobile app(s) on devices (e.g., smart phones, tablets, computers) and buttons or controls built into components of wearable elements of other systems that allow the client associated with the wearable elements to flexibly control various aspects of the system. For example, interface module 374 can provide functionality for a user to ratify a tag via tagging module 372; record a dance sequence in real-time using sequencer module 364; change or approve permissions by way of permissions module 368; and so forth. One of ordinary skill in the art will appreciate the extensive array of soft and hard controls for both controlling such actions, and in situations signaling the possibility for action (e.g., pending relationship suggestion).

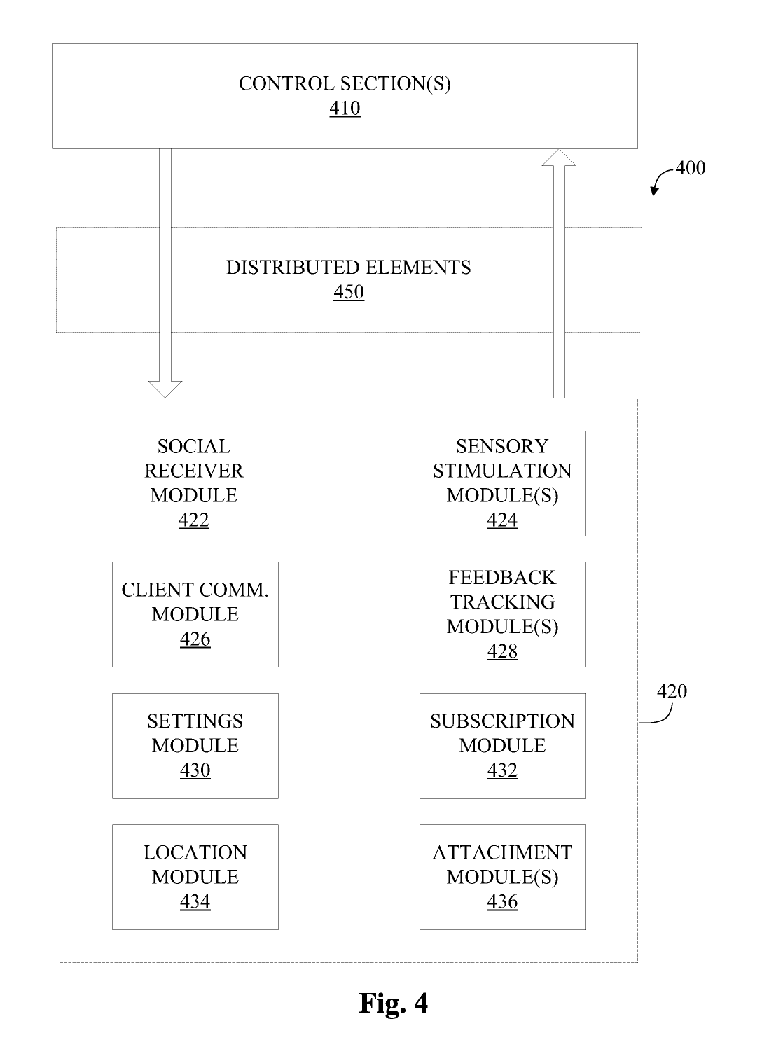

Turning now to FIG. 4, illustrated is an example system 400 having an execution section 420 for performing interactions in a social event.

Social receiver module 422 and sensory stimulation modules 424 generally accord with similar aspects described elsewhere herein. Feedback tracking module(s) 428 can provide the tracking, and in embodiments at least partial analysis, of feedback discovered or provided in accordance with aspects set forth supra. Further, client communications module 426 can be used to communicate between clients (e.g., other members of execution section 420), with control section 410, and with other elements (e.g., distributed elements 450).

Settings module 430 and subscription module 432 permit the user to arrange personal settings associated with one or more events and synchronization signals as set forth herein. Such preferences can be stored locally, or offsite.

Location module 434 conducts location assessment on wearable elements associated with execution section 420. Locations can be determined absolutely (e.g., GPS coordinates) and/or relatively (e.g., direction and distance from other control section 410, position in reference to other wearable elements associated with execution section 420). Further, locations of individual wearable elements or sub-elements can be observed in reference to one another at the sub- or inter-client levels, such as to detect the movements related to a dance or activity, in furtherance of a relationship, effectiveness of training template or sequence, and so forth.

Various techniques can be utilized to such effect. Near field communication (NFC), device-based triangulation, global positioning systems, motion sensors, gyroscopes, and others can be used to establish location. In embodiments, multiple location or motion sensors can be applied to a single user, facilitating location/movement information gathering at higher resolution (e.g., more than single-point, determine movement of individual body parts, and so forth).

Location module 434 can utilize at least one spatial location related to one or more users of one or more groups, and identify one or more devices (or other functional components capable of being leveraged) per user (e.g., worn, carried), to facilitate the creation and distribution of tracks. Location, both absolute and relative, and changes thereto (e.g., large movement for change of venue, moderate movement for change of room in venue, small movement to indicate dancing in a room of the venue) can be monitored, recorded and analyzed. Monitored movement can be applied to or associated with one or more tracks, and the movement can be “played back” with the one or more tracks. In embodiments, recorded movement and other feedback can be isolated for additional uses.

As suggested above, information from or related to location module 434 can be used to identify potential participants. For example, persons having enabled electronics related to particular locations can be identified and invited to attend or prompted to participate. In embodiments, users related to a particular location having similar devices can be prompted with a mutual introduction. In embodiments, users associated with particular information (e.g., similarities) can be “introduced” by the system.

Location module 434 may hybridize location techniques, employing various combinations of radio, visual, and other location techniques. For example, one or more of radio triangulation, visual signaling, and GPS can be used in varying combinations to establish an absolute or relative location.

Attachment module(s) 436 include one or more modules permitting attachment or removal of one or more sensory stimulation module(s) 424 or other components. Attachment modules may be wired or wireless, and include mechanical means for retaining various components in addition to components for exchanging signals and/or power. In embodiments, particular electrical connectors or transmission standards can be utilized to ensure sufficient power or proper connectivity between components and/or other devices.

Various existing technologies can be leveraged in the implementation of some aspects herein. For example, Adafruit FLORA devices can be used with some aspects herein. In another example, Sparkfun Lilypad devices can be used with some aspects herein. In another example, Arduino devices can be used with some aspects herein. In another example, Digi devices can be used with some aspects herein. In another example, Microsoft .net or similar environments can be used with some aspects herein. While the listing of these technologies is provided for purposes of example and to provide an indication of some technologies compatible in particular aspects, it is in no way intended to be construed as exhaustive, exclusive, or limiting. Those skilled in the art will appreciate various technologies appropriate for use in alternative or complementary embodiments.

In embodiments, third-party techniques or integrations can be employed (e.g., Google® Project Glass). For example, systems or methods herein can integrate with the third-party aspects. In other embodiments, systems and methods herein can “outsource” to the third party, using the third party's hardware, or using non-third-party hardware but transmitting information to the third party for processing. In other embodiments, all aspects are wholly contained within systems and methods herein.

While principles and modes of operation have been explained and illustrated with regard to particular embodiments, it must be understood, however, that this may be practiced otherwise than as specifically explained and illustrated without departing from its spirit or scope. For example, while specific placements, configurations and orientations are shown and described herein, it is to be understood that alternative aspects can include alternative placements, configurations and orientations. These alternatives are to be included within the scope of the specification herein. Also, it is to be appreciated that various substitutions in terms of data or media can facilitate similar function. For example, where audio is described, it is to be appreciated that video, audio or combination thereof can be employed in alternative aspects. The innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a social receiver module that receives a synchronization signal based at least in part on a group event;
one or more sensory stimulation modules that actuate based on a stimulation signal;
a stimulation schedule module that generates the stimulation signal based at least in part on the synchronization signal; and
one or more wearable elements that retain at least a portion of the social receiver module, the one or more sensory stimulation modules, and/or the stimulation schedule module.

2. The system of claim 1 further comprising a feedback tracking module that tracks feedback information related to at least the one or more wearable elements.

3. The system of claim 2, wherein a subsequent stimulation signal is provided to the stimulation schedule module based at least in part on the feedback information.

4. The system of claim 2, further comprising a social transmitter that broadcasts a supplemental signal based at least in part on the feedback information.

5. The system of claim 1, further comprising a location module that determines at least one of an absolute location and/or a relative location of the one or more wearable elements.

6. The system of claim 1, further comprising one or more attachment modules configured to variably connect at least one of the one or more sensory stimulation modules to the one or more wearable elements.

7. The system of claim 6, further comprising an electrical interface of the attachment modules capable of providing more than 0.5 amp current to at least one of the one or more sensory stimulation modules.

8. The system of claim 1, further comprising a delay module that delays presenting at least a portion of the group event to permit time coordination of the synchronization signal.

9. The system of claim 1, wherein at least one of the one or more sensory stimulation modules is flexible and/or distributed discontinuously across the one or more wearable elements.

10. The system of claim 1, further comprising an identity module that associates at least one client identifier with at least one of the one or more wearable elements.

11. The system of claim 10, wherein the social receiver module selectively receives the synchronization signal from a plurality of available feeds based on the at least one client identifier.

12. The system of claim 1, further comprising a relationship module that provides a subsequent stimulation signal to the stimulation schedule module based at least in part on a relationship interaction.

13. The system of claim 12, wherein the relationship interaction is defined by at least one relationship classification.

14. A system, comprising:
a social control module that produces one or more synchronization signals based on a group event, the one or more synchronization signals include stimulation information that actuates sensory stimulus modules; and
a social communication module that transmits the one or more synchronization signals to one or more social clients associated with the sensory stimulus modules.

15. The system of claim 14, further comprising a social feedback receiver that receives feedback information associated with the clients.

16. The system of claim 15, wherein the feedback information includes one or more client identifiers associated with the one or more social clients, and wherein the one or more synchronization signals are based at least in part on the one or more client identifiers.

17. The system of claim 15, further comprising a pairing module that manages connections of at least one of the social communications module and the social feedback receiver.

18. A system, comprising:
a control section for administering synchronization of a plurality of wearable social devices;
an execution section for completing synchronized actions with the plurality of wearable social devices;
an identity module that associates at least one client identifier with one or more social clients;
a social control module of the control section that produces at least one synchronization signal based on a group event and the at least one client identifier;
a social communication module of the control section that transmits the at least one synchronization signal to the one or more social clients associated with the sensory stimulus modules;
a social receiver module of the execution section that receives the at least one synchronization signal;
one or more sensory stimulation modules of the execution section that actuate based on at least one stimulation signal;
a stimulation schedule module that generates the at least one stimulation signal based at least in part on the at least one synchronization signal; and
one or more wearable elements of the execution section that retain at least a portion of the social receiver module, the one or more sensory stimulation modules, and/or the stimulation schedule module, wherein the one or more wearable elements are associated with the one or more social clients.

19. The system of claim 18, further comprising:
a feedback tracking module of the execution section that records feedback data associated with the execution section; and
a feedback receiving module of the control section that receives the feedback data,
wherein the at least one synchronization signal is modified based at least in part on the feedback data.

20. The system of claim 18, further comprising a relationship module that detects a relationship interaction, wherein the at least one stimulation signal is based at least on part on the relationship interaction.
